(19) United States
(12) Patent Application Publication
(10) Pub. No.: US 2026/0186834 A1
(43) Pub. Date: Jul. 2, 2026

(54) Register Allocation of Uniformized Multi-Core Programs

(71) Applicant: International Business Machines Corporation, Armonk, NY (US)

(72) Inventors: Masoud Ataei Jaliseh, North York (CA); Jintao Zhang, White Plains, NY (US); Prasanth Chatarasi, White Plains, NY (US); Bardia Mahjour, Newmarket (CA); Wei Wang, Yorktown Heights, NY (US)

(21) Appl. No.: 19/007,987

(22) Filed: Jan. 2, 2025

(51) Int. Cl. G06F 9/50

(52) U.S. Cl. CPC G06F 9/5011; G06F 2209/5012; G06F 2209/508

(57) ABSTRACT

A computer-implemented method for allocating registers for multi-core programs. The method includes generating core-specific programs for execution units of cores, wherein each program contains core-specific configurations. The method includes analyzing the core-specific programs to identify core-specific differences. The method includes creating a uniformized program that consolidates semantics of all programs for the execution units while retaining operations to account for core-specific differences. The method includes performing live range analysis of the uniformized program to identify active intervals for variables and creating segmented live ranges to partition the intervals into global and core-specific segments. The method includes allocating registers to the execution units using the segmented live ranges and multi-casting the uniformized program to the execution units of the cores.

### BACKGROUND

This disclosure relates generally to multi-core programs, and more specifically to register allocation of multi-core programs.

In a multi-core architecture, a single processor (chip) contains multiple processing units or cores. Each core can independently execute instructions, allowing parallel processing of multiple tasks. This architecture is beneficial in compute-intensive applications, like machine learning or large-scale simulations, because tasks can be divided across cores, speeding up execution.

In a decoupled multi-core architecture, compute, load, and store functions are separated into distinct execution units within each core. This allows each type of operation (e.g., performing calculations, retrieving data, or saving data) to occur independently and in parallel. By decoupling these operations, the architecture improves performance by reducing idle time for each execution unit.

Before executing tasks, binaries (e.g., program instructions) required by each execution unit across all cores are loaded into instruction buffers, which are special memory regions where binaries are held before execution. Each execution unit uses its designated instruction buffer, ensuring they are readily available for execution. Instruction buffers act as a queue for the processor, ensuring a steady flow of instructions. Additionally, critical data and operands are loaded into registers, which act as high-speed storage for computations during task execution. A register is a physical storage location within the processor used for holding operands or intermediate results.

In a multi-core, decoupled architecture, the compiler generates programs for each execution unit across all cores. Consequently, multiple separate transfers of programs to the execution units take place.

### SUMMARY

According to an illustrative embodiment, a computer-implemented method for allocating registers for multi-core programs is provided. The method comprises generating core-specific programs for execution units of cores and analyzing the core-specific programs to identify core-specific differences. The method comprises creating a uniformized program that consolidates semantics of all programs for the execution units while retaining operations to account for core-specific differences. The uniformized program includes global regions representing a first set of instructions that are executed uniformly across the cores and core-specific regions representing a second set of instructions unique to each core that are selected based on the identity of the core. The method comprises performing live range analysis of the uniformized program to identify active intervals for variables and creating segmented live ranges to partition the intervals into global and core-specific segments. The segmented live ranges are labeled to associate each segment with its corresponding execution context or core-specific region. The method comprises allocating registers to the execution units using the segmented live ranges and multi-casting the uniformized program to the execution units of the cores. The method further comprises constructing an interference graph from the segmented live ranges. Nodes in the interference graph represent the variables and edges between the nodes represent overlapping live ranges, indicating the variables that cannot share the same register. The method comprises creating a pre-coloring graph from the interference graph, where same color edges are added to the nodes that are semantically related. The method comprises grouping the nodes that are semantically related and assigning the same color to edges between nodes that are semantically related. The method comprises grouping the nodes that are connected to each other via the same color edges and merging the edges to form a hyperedge. The method comprises constructing a colored hypergraph, where nodes in the colored hypergraph represent the variables, an edge between two nodes indicates that the corresponding variables cannot share the same register, the nodes not connected by an edge are assigned the same color to share a register and the nodes connected via the hyperedge are considered as a single node for the purpose of coloring. According to other illustrative embodiments, a system and a computer program product for allocating registers for multi-core programs are provided.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a computing environment in which illustrative embodiments may be implemented;

FIGS. 2, 3 and 4 illustrate uniformized programs in accordance with illustrative embodiments;

FIG. 5 illustrates a static single assignment (SSA) live range in accordance with an illustrative embodiment;

FIG. 6 illustrates labeled segmented intervals in accordance with an illustrative embodiment;

FIG. 7 illustrates an interference graph in accordance with an illustrative embodiment;

FIG. 8 illustrates a pre-coloring graph in accordance with an illustrative embodiment;

FIG. 9 illustrates a hypergraph in accordance with an illustrative embodiment; and

FIG. 10 illustrates a colored hypergraph in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one or more storage media (also called “mediums”) collectively included in a set of one or more storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

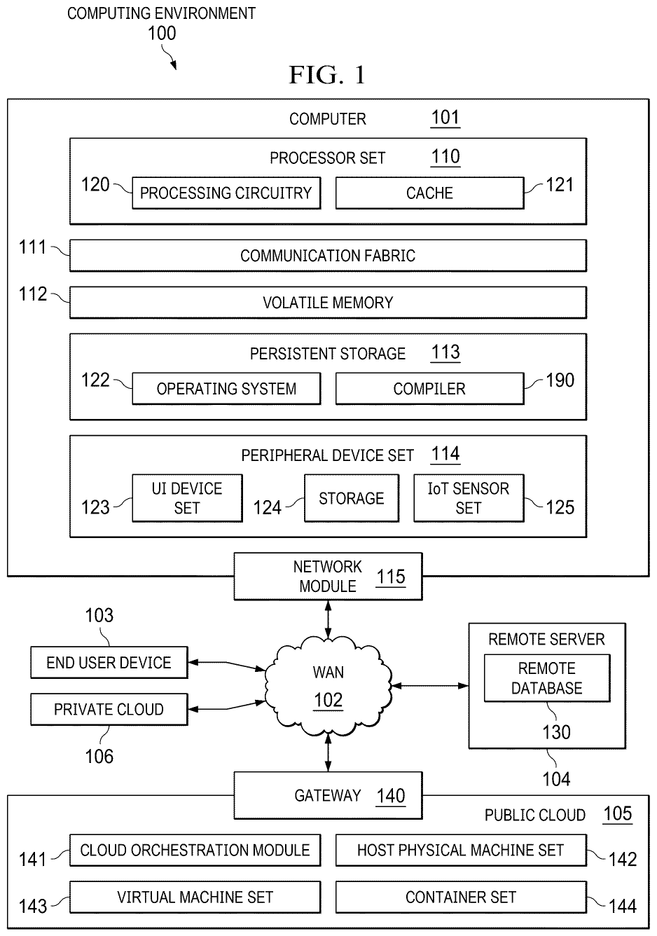

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods, such as compiler 190. In computing environment 100, compiler 190 is a software program that translates high-level source code into low-level machine code (binary instructions) that can be executed by processor set 110. The compilation process may involve generating intermediate code (e.g., platform-independent representation of the source-code), converting the intermediate code into machine code (binaries), and outputting the final machine code for execution.

In addition to compiler 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and compiler 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one or more computer processors of any type now known or to be developed in the future. Processing circuitry 120 may be distributed over multiple packages, for example, multiple coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions and associated data are accessed by processor set 110 to control and direct performance of the inventive methods. In computing environment 100, at least some of the instructions for performing the inventive methods by compiler 190 may be stored in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in compiler 190 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data application portability between the multiple constituent clouds. In this embodiment, public cloud 105 and private cloud 106 are both part of a larger hybrid cloud.

Cloud Computing Services and/or Microservices: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

According to an illustrative embodiment, a computer-implemented method for allocating registers for multi-core programs is provided. A multi-core program is a set of instructions designed to run on a multi-core architecture, where each core executes part of the program or performs specific tasks assigned to it.

In an illustrative embodiment, a compiler generates uniformized programs for execution units across multiple cores. The uniformized programs are generated by analyzing core-specific programs. The uniformized programs consolidate the functionalities of the separate programs while handling core-specific differences. The uniformized programs are highly similar but not identical. Differences typically involve aspects like memory addresses or core-specific configurations. An execution unit is a hardware component within a core that performs specific types of operations or tasks. In a multi-core architecture, each core may consist of multiple specialized execution units, such as units for arithmetic computations, data loading, or data storage.

The uniformized programs are transferred to the execution units across the cores. Instead of transferring unique programs to each core, a nearly identical program for one core (e.g., Core-0) is multi-cast to all cores (e.g., Core-1, Core-2). This reduces data transfer overhead, as only a single uniformized program is sent to all cores, significantly improving efficiency. In some example embodiments, different uniformed regions in cores are provided different sets of instructions.

After multi-casting the uniformized programs, small patches are applied to handle core-specific differences. For example, Core-1 may use a different memory address for a variable like input1 or output. Instead of re-transferring a new program, the necessary adjustments are applied as minor updates (patches). These patches are lightweight and reduce the need for larger, redundant transfers.

In accordance with illustrative embodiments, the compiler analyzes live ranges of variables in the uniformized program. A live range is the interval during which a variable is active and needs to reside in a register. The compiler creates segmented live ranges that define the periods during which variables are active, along with labels for each range. The segmented live range provides the compiler with precise intervals and labels, enabling efficient register allocation.

Because the programs are uniform, the compiler can optimize register usage. For example, if Register R1 is used for variable %X on core-0, it can also be used for variable %X on all other cores. If variable %X may need a register during the first half of the program's execution, that register can be freed up for other variables afterward. Based on the intervals and labels, the compiler assigns registers for the variables.

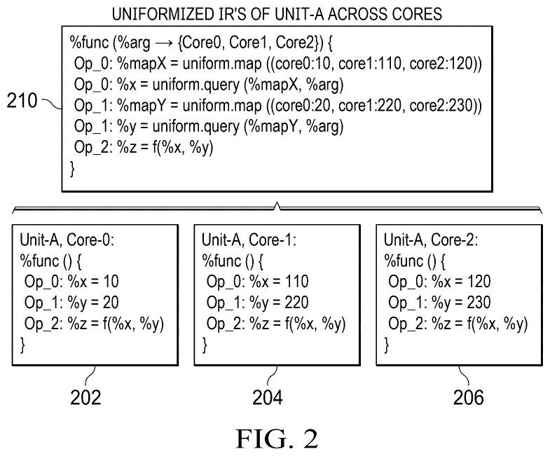

FIG. 2 illustrates an example of generating a uniformized program by analyzing core-specific programs generated for different cores (e.g., Core-0, Core-1, Core-2). The uniformized program consolidates the functionality of the separate programs while handling core-specific differences.

Initially, separate programs 202, 204 and 206 are generated for execution units of respective cores Core-0, Core-1 and Core-2. Each binary contains instructions specific to that core's requirements.

In the illustrative example, the following programs are created:
Core-0: %x=10, %y=20, %z=f(%x, %y)
Core-1: %x=110, %y=220, %z=f(%x, %y)
Core-2: %x=120, %y=230, %z=f(%x, %y)

Each program performs similar operations but uses distinct constant values (%x and %y). The compiler identifies core-specific differences between the binaries:
%x has values 10, 110, 120 for Core-0, Core-1, and Core-2, respectively;
%y has values 20, 220, 230 for Core-0, Core-1, and Core-2, respectively.

These differences are constant and predictable, making them suitable for optimization using a uniformized representation. The compiler creates uniformized program 210 using uniform.map and uniform.query operations to handle core-specific differences.

Uniformized Program:

```
%func (%arg → { Core-0, Core-1, Core-2}) {
  Op_0: %mapX = uniform.map ((core-0:10, core-1:110, core-2:120))
  Op_0: %x = uniform.query (%mapX, %arg)
  Op_1: %map Y = uniform.map ((core-0:20, core-1:220, core-2:230))
  Op_1: %y = uniform.query (%mapY, %arg)
  Op_2: %z = f(%x, %y)
}
```

In the illustrative embodiment:
(1) uniform.map: maps core-specific values to their corresponding cores;
(2) uniform.query: fetches the constant value for the core specified by %arg;
(3) %arg: specifies the core being executed (e.g., Core-0, Core-1, Core-2).

The compiler generates a binary for uniformized program 210, which is multi-casted to all cores, avoiding the need to transfer individual binaries for each core. During code generation, the compiler uses uniform. query to extract the core-specific constants (%x and %y) from uniform. map for each core.

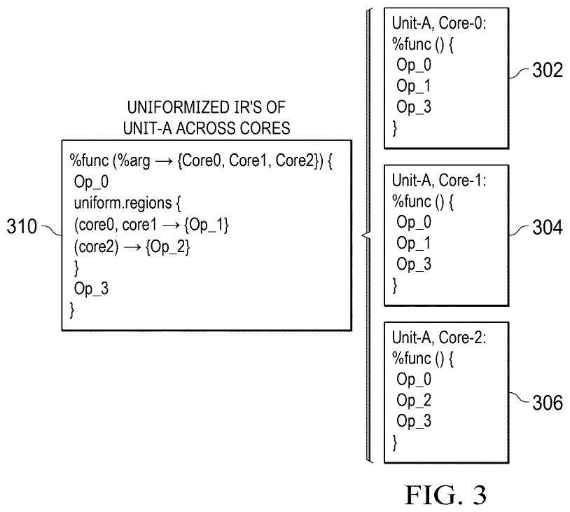

FIG. 3 illustrates another example of creating a uniformized program by analyzing core-specific programs for cores Core-0, Core-1 and Core-2. A core-specific program is set of instructions tailored to run on a specific core within a multi-core architecture. The core-specific program accounts for the individual roles or tasks of each core. The uniformized program consolidates core-specific programs into a single, unified program that accounts for core-specific operations.

Initially, programs 302, 304 and 306 are generated for execution units of respective cores Core-0, Core-1 and Core-2. Each program contains instructions specific to that core's requirements. The compiler identifies core-specific differences between the binaries:
(1) Core-0 and Core-1 share the same sequence: Op_0, Op_1, Op_3;
(2) Core-2 shares Op_0 and Op_3 with Core_0 and Core_1 but replaces Op_1 with Op_2.

Thus, Op_0 and Op_3 are shared across all cores. Op_1 appears in Core_0 and Core_1, whereas Op_2 appears only in Core_2.

The compiler merges these core-specific programs into uniformized program 310, which is a compact representation of the programs for all cores.

Uniformized Program 310:

```
%func (%arg -> { Core0, Core1, Core2}) {
  Op_0
  uniform.regions {
    (core0, core1) ⋄ {Op_1}
    (core2) ⋄ {Op_2}
  }
  Op_3
}
```

Op_0 and Op_3: Executed uniformly across all cores.

In the illustrative example, the operation uniform. regions handle core-specific differences, and the operation %arg identifies the target core (Core-0, Core-1, or Core-2). The operation (Op_1 or Op_2) is selected based on %arg.

The compiler generates a single binary from the uniformized program which is multi-casted to all cores, avoiding the need to transfer separate binaries. Once the program is multicasted, each execution unit has its copy of the program which is executed.

In the illustrative example, each core executes the shared operations: Op_0 and Op_3. Core-specific operations are selected from uniform.regions based on the core's identity.

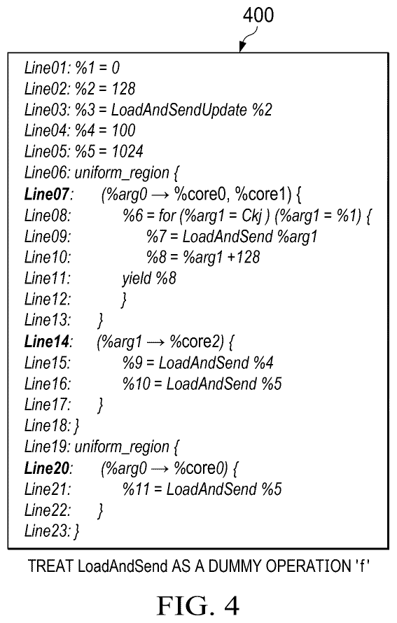

FIG. 4 illustrates unformized program 400 in accordance with an illustrative embodiment. A live range analysis is performed on uniformized program to create segmented live ranges.

Uniformized program 400 includes global regions which are executed across all cores and local (specific) regions which are executed by specific cores or processing units. Uniformized program 400 integrates data and control flow across these regions to ensure uniform representation for different core and/or execution units.

In the illustrative embodiment, lines 01-05 are used for global initializations:
Line 01: initializes %1 to 0.
Line 02: initializes %2 to 128.
Line 03: %3 is a function call to load and send an update based on %2.
Line 04: initializes %4 to 100
Line 05: initializes %5 to 1024.

A first uniform region begins at line 06 and contains two separate regions representing core or unit-specific instructions.

Region 1 represents instructions that are executed by %Core0 and %Core1 (lines 07-13). Region 2 represents instructions that are executed by %Core2 (lines 14-17). A second uniform region begins at line 019 and is executed by %Core0.

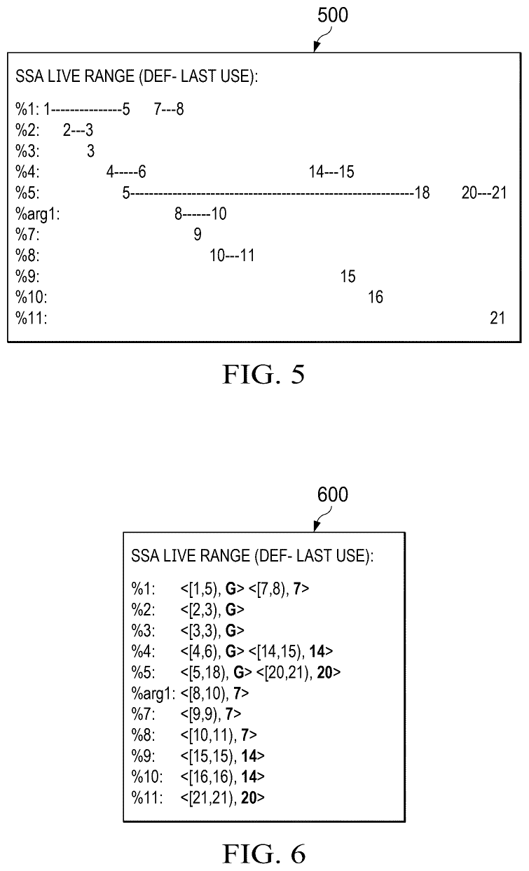

FIG. 5 illustrates static single assignment (SSA) live range 500 which is created by the compiler using uniformized program 400. In the SSA form, each variable is assigned exactly once, and every variable assignment is unique. The SSA form simplifies optimization and analysis, as each variable can be traced to its definition. The compiler determines where each variable is live in the uniformized program (e.g., where variable is defined and used) and the last point where the variable is used before becoming irrelevant. The compiler constructs live range 500 by marking all lines in the program where the variable is live, from definition to last use.

FIG. 6 illustrates labeled segmented intervals 600 in accordance with an illustrative embodiment. As shown, gaps can exist between the segmented intervals. In this example, the compiler creates labeled segmented intervals 600 based on live range 500. A labeled segmented interval represents a partition of an SSA variable's live range as it pertains to distinct segments (active intervals), each associated with a label. An active interval [start, end) defines a segment of the live range and the label represents the context or scope where the interval is active.

For example, in FIG. 6, variable %1 has live range <[1,5), G> (Global context G) and <[7,8), 7> (specific to uniform region 7). Thus, in the global scope (G), %1 is live from lines 1 to 5, and in a core-specific region, %1 is live again between lines 7 and 8. Variable %2 is live only between lines 2 and 3 in the global context. Variable %arg1 is live in a loop between lines 8 and 10, in a core-specific region.

The labeled segmented live ranges are used by the compiler for register allocation. The compiler identifies when and where variables are live (i.e., in use) and ensures efficient mapping of these variables to the registers. The compiler uses this information to minimize register usage by reusing registers where possible and avoids conflicts by ensuring no two live variables at the same time use the same register.

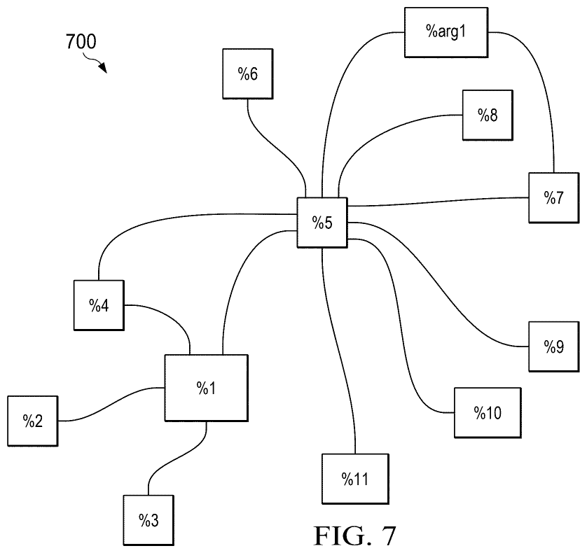

In an illustrative embodiment, the compiler constructs a graph from the segmented live ranges. FIG. 7 illustrates graph 700 constructed from segmented live ranges 600 (shown in FIG. 6). Graph 700 is also referred to as an interference graph. In graph 700, SSA variables (e.g., %1, %2, %arg1) are represented by nodes. An edge (e.g., line) between two nodes indicates their live ranges overlap, meaning they cannot share the same register.

For example, the live ranges of %1 and %2 overlap, and thus %1 and %2 are connected by an edge. Similarly, the live ranges of %arg1, %5 and %7 overlap, and thus these variables are connected by edges.

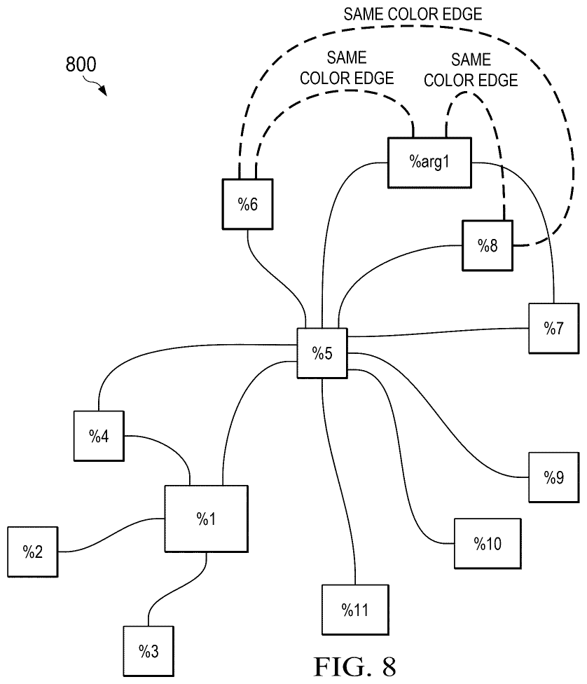

In accordance with an illustrative embodiment, a pre-coloring graph is created from a graph. FIG. 8 illustrates colored graph 800 which is created from graph 700. In pre-coloring graph 800, edges between nodes are given the same color when their variables are semantically related in special ways. Same-colored edges imply that these variables are expected to share the same register for efficiency. Coloring their edges the same simplifies register allocation, ensuring related variables are allocated consistently. For example, variables %6, %arg1, and %8 in uniformized program 400 (shown in FIG. 4) are all part of a closely related chain of dependent variables. This connection is represented by same-colored edges in colored graph 800.

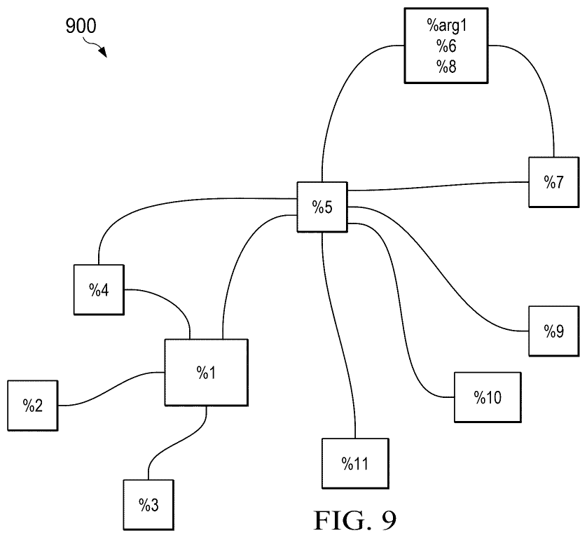

Based on pre-color graph 800, a hypergraph is created. FIG. 9 illustrates hypergraph 900 which is created from pre-color graph 800. Hypergraph 900 is an abstraction of graph 800 (shown in FIG. 8).

In hypergraph 900, nodes from graph 800 are grouped together if they are connected to each other via same-color edges. Once the group of same-color nodes are identified, a hyperedge is formed to connect them together. For example, variables %6, %arg1, and %8 in the uniformized program are all part of the scalar recursion in the “for loop” (lines 08-11). Thus, variables %6, %arg1, and %8 are grouped together. Merging these nodes reduces the graph's complexity and optimizes the register allocation.

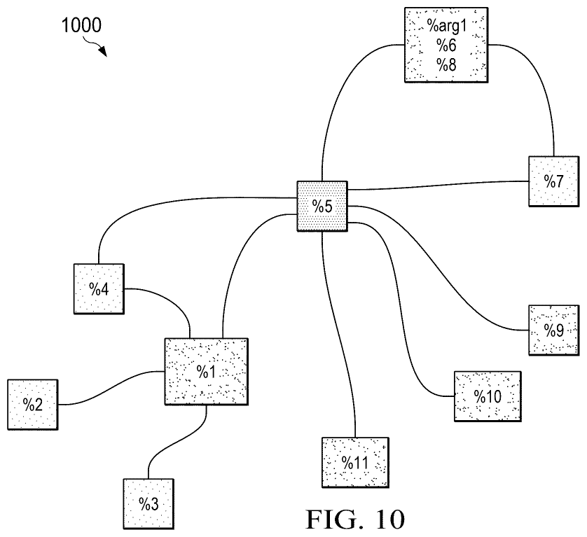

Finally, graph coloring technique is used to create colored hypergraph 1000 as shown in FIG. 10. In this method, no two nodes connected by an edge share the same color, while nodes not connected by an edge can share the same color. Nodes connected via a hyperedge are considered a single node for the purpose of coloring.

Using colored hypergraph 1000, the compiler allocates registers. Nodes sharing the same color can use the same register, whereas nodes with different colors cannot share a register. Thus, variables %2, %3, %4 and %7 can share a register, and variables %1, %9, %10, %11 and variables in merged node (%arg1, %6 and %8) can share a register.

As used herein, a first component “connected to” a second component means that the first component can be connected directly or indirectly to the second component. In other words, additional components may be present between the first component and the second component. The first component is considered to be indirectly connected to the second component when one or more additional components are present between the two components. When the first component is directly connected to the second component, no additional components are present between the two components.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method for allocating registers for multi-core programs, the method comprising:
generating core-specific programs for execution units of cores, each program containing core-specific configurations;
analyzing the core-specific programs to identify core-specific differences;
creating a uniformized program that consolidates semantics of all programs for the execution units while retaining operations to account for the core-specific differences;
performing live range analysis of the uniformized program to identify active intervals for variables;
creating segmented live ranges to partition the intervals into global and core-specific segments;
allocating registers to the execution units using the segmented live ranges; and
multi-casting the uniformized program to the execution units of the cores.

2. The computer-implemented method of claim 1, wherein the uniformized program comprises:
global regions representing a first set of instructions that are executed uniformly across the cores; and
core-specific regions representing a second set of instructions unique to each core that are selected based on the identity of the core.

3. The computer-implemented method of claim 1, wherein the segmented live ranges are labeled to associate each segment with its corresponding execution context or core-specific region.

4. The computer-implemented method of claim 1, further comprising constructing an interference graph from the segmented live ranges, wherein:
nodes in the interference graph represent the variables; and
edges between nodes represent overlapping live ranges, indicating the variables that cannot share the same register.

5. The computer-implemented method of claim 4, further comprising creating a pre-coloring graph from the interference graph, wherein same color edges are added to the nodes that are semantically related.

6. The computer-implemented method of claim 4, further comprising:
grouping the nodes that are semantically related; and
assigning the same color to edges between nodes that are semantically related.

7. The computer-implemented method of claim 6, further comprising:
grouping the nodes that are connected to each other via the same color edges; and
merging the edges to form a hyperedge.

8. The computer-implemented method of claim 7, further comprising constructing a colored hypergraph, wherein:
the nodes in the colored hypergraph represent the variables;
an edge between two nodes indicates that the corresponding variables cannot share the same register;
the nodes not connected by an edge are assigned the same color to share a register; and
the nodes connected via the hyperedge are considered as a single node for the purpose of coloring.

9. The computer-implemented method of claim 1, wherein the live range analysis comprises determining:
a definition and last use points for each variable; and
intervals during which each variable remains active within the program.

10. The computer-implemented method of claim 1, wherein the segmented live ranges are created in a static single assignment (SSA) form.

11. The computer-implemented method of claim 1, further comprising applying patches to the uniformized program at each core to implement core-specific differences.

12. A computer system comprising:
a processor set;
one or more computer-readable storage media; and
program instructions stored on the one or more storage media to cause the processor set to perform operations comprising:
generating core-specific programs for execution units of cores, each program containing core-specific configurations;
analyzing the core-specific programs to identify core-specific differences;
creating a uniformized program that consolidates semantics of all programs for the execution units while retaining operations to account for the core-specific differences;
performing live range analysis of the uniformized program to identify active intervals for variables;
creating segmented live ranges to partition the intervals into global and core-specific segments;
allocating registers to the execution units using the segmented live ranges; and
multi-casting the uniformized program to the execution units of the cores.

13. The computer system of claim 12, wherein the uniformized program comprises:
global regions representing a first set of instructions that are executed uniformly across the cores; and
core-specific regions representing a second set of instructions unique to each core that are executed conditionally based on the identity of the core.

14. The computer system of claim 12, wherein the operations further comprise:
constructing an interference graph from the segmented live ranges, wherein:
nodes in the interference graph represent the variables; and
edges between nodes represent overlapping live ranges, indicating the variables that cannot share the same register.

15. The computer system of claim 14, wherein the operations further comprise creating a pre-coloring graph from the interference graph, wherein same color edges are added to the nodes that are semantically related.

16. The computer system of claim 15, wherein the operations further comprise:
grouping nodes that are connected to each other via the same color edges; and
merging the edges to form a hyperedge.

17. The computer system of claim 16, wherein the operations further comprise:
constructing a colored hypergraph, wherein:
the nodes in the colored hypergraph represent the variables;
an edge between two nodes indicates that the corresponding variables cannot share the same register;
the nodes not connected by an edge are assigned the same color to share a register; and
the nodes connected via the hyperedge is considered as a single node for the purpose of coloring.

18. A computer program product comprising:
one or more computer-readable storage media;
program instructions stored on the one or more storage media to perform operations comprising:
generating core-specific programs for execution units of cores, each program containing core-specific configurations;
analyzing the core-specific programs to identify core-specific differences;
creating a uniformized program that consolidates semantics of all programs for the execution units while retaining operations to account for the core-specific differences;
performing live range analysis of the uniformized program to identify active intervals for variables;
creating segmented live ranges to partition the intervals into global and core-specific segments;
allocating registers to the execution units using the segmented live ranges; and
multi-casting the uniformized program to the execution units of the cores.

19. The computer program product of claim 18, wherein the operations further comprise
constructing an interference graph from the segmented live ranges, wherein:
nodes in the interference graph represent the variables; and
edges between nodes represent overlapping live ranges, indicating the variables that cannot share the same register.

20. The computer program product of claim 19, wherein the uniformized program comprises:
global regions representing a first set of instructions that are executed uniformly across the cores; and
core-specific regions representing a second set of instructions unique to each core that are executed conditionally based on the identity of the core.
